(19) United States
(12) Patent Application Publication
(10) Pub. No.: US 2025/0147791 A1
(43) Pub. Date: May 8, 2025

(54) CONFIGURATION OF ELECTRONIC COMPONENTS BASED ON SOFTWARE CONTAINERS

(71) Applicant: WAGO Verwaltungsgesellschaft mbH, Minden (DE)

(72) Inventors: Dirk MEIHOEFER, Minden (DE); Jan JENKE, Herford (DE); Sergei IKKERT, Minden (DE)

(73) Assignee: WAGO Verwaltungsgesellschaft mbH, Minden (DE)

(21) Appl. No.: 18/939,605

(22) Filed: Nov. 7, 2024

(30) Foreign Application Priority Data
Nov. 7, 2023 (DE) 10 2023 130 777.0

(51) Int. Cl. G06F 9/455; G06F 8/61

(52) U.S. Cl. CPC G06F 9/45558; G06F 8/63; G06F 2009/45562; G06F 2009/45575

(57) ABSTRACT

A method for configuring an electronic component is provided. The electronic component may, in particular, be a field device and/or an automation device and/or a building technology device. The method may comprise creating a software container which is executable on the electronic component to configure the electronic component according to configuration information. The method may comprise providing an instruction which, when executed on the electronic component, causes the electronic component to retrieve and/or execute the software container. The method may comprise providing the software container to the electronic component.

This nonprovisional application claims priority under 35 U.S.C. § 119(a) to German Patent Application No. 10 2023 130 777.0, which was filed in Germany on Nov. 7, 2023, and which is herein incorporated by reference.

### BACKGROUND OF THE INVENTION

### Field of the Invention

The present invention relates generally to the technical field of the configuration of industrial products, in particular of electronic components, for example, in the form of field devices and/or automation devices and/or building technology devices.

### Description of the Background Art

Today's technological landscape is subject to an ever-increasing degree of interconnection between a wide variety of devices and components. This is particularly the case in highly complex environments, such as infrastructure utilities, factories, buildings, etc. In such environments, a large number of electronic components is used. For example, field devices, automation devices or building technology devices. In order to efficiently manage and maintain these electronic components, it is typically necessary to configure them with respect to their software.

Previous solutions for the configuration of such electronic components, which may be installed in various functional environments after production, are usually based on a direct communication connection between the electronic components and a configuring entity. There, the configuring entity sends the configuration and/or the like to the electronic components. However, direct communication connections provided for this purpose pose a security risk.

The problem can be easily explained based on the example of building technology devices. Building technology devices are technical components inside and outside of buildings that serve the use of said buildings. For example, building technology devices include sun protection systems, lighting systems, fire alarm systems, burglar alarm systems, photovoltaic systems, or access control systems. Thus, there are security-relevant and less security-relevant building technology devices. Burglar alarm systems, for example, are security relevant. All security-relevant building technology devices should only be configured by authorized persons. At the same time, however, the configuration should be as efficient and simple as possible. Building technology devices are sometimes also referred to as building services systems, technical building equipment or supply technology.

U.S. Pat. No. 9,568,908 B2 discloses a cloud-based system for providing industrial applications. The industrial applications on cloud platforms can be made available to developers and end users with access rights to the cloud platform. Application developers can publish industrial applications to an application library on the cloud platform, where the application is cataloged within an industry-specific search hierarchy. Through a search engine, a user can access the cloud platform and search for a desired industrial application. The library's hierarchical catalog allows the user to search for applications according to the type of industry, equipment used, type of automation system, or other appropriate criteria.

Furthermore, EP 2 758 872 B1, which corresponds to U.S. Pat. No. 9,632,494, discloses a method for generating and handling component applications for, for example, a PLC, in which component functions in the form of object types from component models or function models stored in a library (BIB) with defined references and parameter sets for the component functions to be used as well as their communication, logic and variables are made available in a cloud-based environment and then loaded into the PLC.

### SUMMARY OF THE INVENTION

It is therefore an object of the present invention to provide a method which allows a secure and simple configuration of electronic components and thus at least partially overcomes the above-mentioned disadvantages of existing solutions.

In an example, a method is provided for configuring an electronic component. The electronic component may, in particular, be a field device and/or an automation device and/or a building technology device. The method may comprise creating a software container which is executable on the electronic component to configure the electronic component according to configuration information. The method may comprise providing an instruction which, when executed on the electronic component, causes the electronic component to retrieve and/or execute the software container. The method may comprise providing the software container to the electronic component.

The term “electronic component” can refer to any electronic device and/or system that is configurable, in particular with respect to its software, to perform certain functions and/or exhibit specific properties.

For the purposes of the present invention, a field device can be understood to be any type of device that can be used in industrial applications to perform measurements and/or operations. Examples of this may be electrical switches, bus systems, electrical measuring devices, and/or the like.

The term “automation device” can refer to devices that may automatically control, regulate, and/or monitor processes without, or substantially without, human intervention. They may be part of industrial control and regulation systems and may include, for example, PLCs, robot systems, or production control systems.

For the purposes of the present invention, the term “building technology device” can be understood to mean all permanently installed and mobile technical systems inside and outside a building that serve the use of said buildings. Examples of building technology devices include sun protection systems, air conditioning systems, heating systems, lighting systems, fire alarm systems, burglar alarm systems, photovoltaic systems, or access control systems.

The term “configuration” can refer, in particular, to the setting of an electronic component, to the adjustment of a setting of an electronic component, to the parameterization of an electronic component, to an adjustment of the parameterization of the electronic component, and/or to the provision of functionalities. The aim of a configuration may be for the electronic component to perform functions and/or to achieve certain behaviors and/or to have certain properties. Configuration processes may, in particular, be the programming and/or setting of parameters.

In this context, configuration information is specific information, parameters, and/or data used to configure the electronic component. This information may include user input, operating settings, and/or specific programming codes. For example, they may contain information about the operating mode, network details, and/or other specific settings, and/or parameters required to perform a particular function or task.

The term “software container” may refer to a technology that enables consistent, reliable execution of software across different processor environments. A software container contains program code and associated dependencies (libraries, runtime environment, environment variables, and/or the like). A software container may be used in particular to implement a configuration on the electronic component and/or to install an application on the electrical component that provides the electronic component with certain functionalities. In this context, providing the software container to the electronic component can mean that the entity carrying out the configuration (be it a server, a cloud platform, or a mobile device) provides the electronic component with the created software container in that the electronic component can retrieve it, in particular download it, in particular according to the pull principle.

One of the advantages of using software containers is that they provide a consistent and reproducible environment. Regardless of which electronic component a particular software container is running on, the applications it contains, and their dependencies remain the same. A well-known example of a software container technology is Docker. Docker makes it possible to package and distribute applications in containers that can then be run on any electronic component using Docker. The main features and benefits of Docker include:
Portability: Docker software containers can be built and run on any system that supports Docker, regardless of the operating system.
Versioning: Docker can track changes to a software container and create different versions of software containers, making it easy to go back to previous versions and check differences and their impact.
Reusability: Already created software containers can be reused and combined to create new applications.
Isolation: Each software container can run independently of others, meaning each application runs in a secure environment.

There are several alternatives to Docker. For example, Podman, containerd, CRI-O, Rocket, and Linux Containers.

The term “instruction” can refer to specific commands or codes that are executable on the electronic component to retrieve, in particular according to the pull principle, and/or execute a software container. Instructions may be written in different programming languages and might vary from a simple string of characters to complex software code.

In the present context, the term “retrieval” may include, in particular, downloading, for example according to the pull principle. In relation to the software container, this may mean that the electronic component establishes a connection to the entity where the software container is stored in order to download or import it. The entity may be, for example, a server or a cloud platform.

The term “execution” can refer here to the process of implementing and/or applying an instruction and/or software code. With respect to the software container, this means, in particular, that the electronic component may execute software code within the software container to perform a specific configuration task.

The proposed method for configuring an electronic component according to the first aspect of the present invention offers various advantages, in particular in terms of safety/security, flexibility, efficiency, and consistency. The use of software containers increases safety when configuring electronic components because software containers are created based on ready-made libraries. Furthermore, if the software containers are retrieved from the electronic component using the pull principle, this avoids that an instance outside the electronic component sneaks malware and/or an unwanted configuration onto the electronic component.

Furthermore, a high level of flexibility and adaptability is achieved by creating a software container that can be used to perform the configuration of the electronic component. It enables an individual configuration tailored to the specific needs and requirements, be it a field device, an automation device or a building technology device.

Providing an instruction that causes the electronic component to retrieve and/or execute the software container ensures that the configuration processes are carried out timely and efficiently. This minimizes process delays and maximizes the operating time of the electronic component. In addition, this method helps improve accuracy by avoiding human errors that could occur during manual configuration.

Finally, providing the software container to the electronic component enables consistent and reliable configuration across different platforms and operating systems. Since the container contains all necessary dependencies, the risk of incompatibility issues is minimized. This saves time and resources for troubleshooting and ensures smooth and effective functioning of the electronic component. In other words, by applying this method, the benefits of standardization, scalability, safety/security, reusability and high flexibility can be exploited.

Preferably, the method is at least partially performed by a server, preferably by a cloud platform, and/or by a mobile device, preferably a smartphone.

For example, it is conceivable that an on-site technician logs onto the cloud platform via his smartphone to start or monitor the configuration process. A server or cloud platform as the execution location allows flexibly scaling the necessary resources (such as storage space and/or computing power) and storing and managing all configuration information centrally. In particular, several electronic components can advantageously be configured simultaneously and consistently. The ability to perform the procedure using a mobile device makes it possible to respond quickly to potential problems or change requests.

Preferably, the method further comprises receiving the configuration information, preferably through user inputs via a user interface, for the electronic component. The creating of the software container may be carried out, in particular, based on the configuration information. A user interface may in particular comprise a mobile device, a computer, and/or other suitable devices.

Users, in particular owners of the electronic components and/or administrators, may enter specific configurations and/or parameters which may then be used to configure the electronic component.

For example, a user may enter desired operating modes, network details and/or other specific settings via a user interface on their smartphone or computer. These user inputs may be used as configuration information. Based on this configuration information, the software container may be created. The software container thus created may then contain all the information and dependencies needed to configure the electronic component according to the user input.

This allows for a high degree of configuration adaptability. Users may easily enter their specific requirements and/or needs so that the electronic components can be precisely tailored to them during configuration. This creates a flexible and needs-based configuration process and enables a configuration to be documented in a traceable manner, as user input can be saved and made available at a later date.

Preferably, the method further comprises creating a software container image based on configuration information. The software container image comprises, in particular, computer-readable instructions and information about the runtime environment and/or libraries and/or environment variables. The creation of the software container may be carried out, in particular, based on the software container image. The created software container image may, in particular, be unchangeable.

Creating a software container image based on the configuration information may be regarded as templating the software container. The software container image may, in particular, contain all necessary information about the runtime environment as well as relevant libraries and environment variables. Thus, the actual software container, which is used to configure the electronic component, may be created based on a software container image. This step may, in particular, comprise converting the software container image into an executable format, thus becoming a software container.

The created software container image may be unchangeable. This provides a high level of security and durability as it ensures that the original state of a software container image is preserved and not accidentally or unauthorizedly modified. A software container image may be saved after the creation of an associated software container and preferably associated with the underlying configuration information and/or the associated software container, so that it is possible to trace at a later point in time which configuration information and/or software container image caused a certain behavior of the configured electronic component. A clear demarcation of the individual steps of the configuration process facilitates the implementation of the procedure and increases reliability and traceability.

It may further be contemplated that the software container image is created based on a library of image templates.

Such templates may represent blueprints for different types of software containers and may contain different configuration parameters and environment variables. For example, the library may store different templates for different types of electronic components—for example, for different types of industrial measuring instruments or automation devices. When creating a software container image, a suitable template based on which the actual software container image is created can be selected first.

By providing different templates, it is not necessary to create a completely new software container image each time. Instead, the templates that already contain most or all of the required configuration parameters and environment variables can be reused. This simplifies the process and makes it faster and more efficient. In addition, the use of templates enables a high level of consistency and reliability, as proven and tested templates can be reused.

Preferably, the instruction is provided in response to an instruction query of the electronic component, in particular according to the pull principle.

Preferably, the software container is provided in response to an container availability query of the electronic component, in particular according to the pull principle.

For example, the electronic component may actively send a request to a server or cloud platform when it is ready for configuration. It may be envisaged that the instruction to retrieve and/or execute the software container is only provided after this request.

This will bring about some beneficial effects. On the one hand, the efficiency of the process is increased because a server and/or a mobile device does not have to constantly check whether the electronic component is ready for configuration. Instead, the instruction is only provided when the component itself signals that it is ready. This reduces communication effort and ensures that the configuration process starts exactly when the electronic component is ready for it. On the other hand, the security of the configuration process is increased because the instruction is only provided upon request and is not constantly available. In other words, a server, a mobile device, or another entity cannot make a configuration change to the electronic component without the electronic component requesting or querying it. Instead of a push principle, a pull principle is used. This reduces or almost completely eliminates the likelihood of malicious, unwanted configurations of the electronic component.

It may further be contemplated that the instruction query and/or the container availability query is repeated in a time-controlled manner, preferably periodically. Alternatively or additionally, it may be provided that the instruction query and/or the container availability query is carried out based on a query command.

Repeating a statement query and/or a container availability query in a time-controlled manner, preferably periodically, may be implemented by the electronic component sending a request at regular intervals to check whether there is a new instruction to retrieve and/or execute a software container and/or whether the software container is available. Such an approach is particularly advantageous in use cases involving electronic components which need to be regularly updated and/or reconfigured—for example, when operating conditions change frequently.

Alternatively or additionally, it may be provided that the instruction query and/or the container availability query is carried out based on a specific query command. In this case, the electronic component may only send a request when it receives a specific command to do so. Such a command may be given, for example, by a user, in particular, by pressing a button on the electronic component and/or by establishing a connection to a mobile device, wherein it may preferably be a prerequisite that the mobile device is an authorized mobile device and, in particular, that the electronic component carries out the authorization. An authorization by the electronic component may, for example, be carried out based on a whitelist stored on the electronic component. A time-controlled query, on the other hand, has the advantage that it occurs automatically and regularly and therefore does not require any activity on the part of the user.

Preferably, several software containers are created based on the configuration information. The method may further comprise determining an order for the execution of the multiple software containers, in particular based on a set of rules and/or based on a collision check.

Creating multiple software containers may allow managing different aspects of the electronic component configuration. For example, separate software containers may be created to control and manage different operating modes, network settings, or other specific settings. Each of these software containers may be created according to the specific configuration information. In addition to creating multiple software containers, the method may also include specifying a particular execution order for those containers. Such an order may be determined, for example, based on a predefined set of rules or on the basis of a collision check. The latter means that it is checked whether the execution of certain software containers could potentially create conflicts or “collisions” in the configuration, and the order may be adjusted accordingly to avoid them. For example, a first software container may perform a partial or complete reset of the electronic component, and a second software container may perform a reconfiguration. If the second software container is executed before the first software container on the electronic component, this will not lead to the desired result. Only executing the first software container first and the second software container afterwards will result in the electronic component receiving the desired new configuration.

According to a second aspect of the present invention, a method for configuring an electronic component, in particular a field device and/or an automation device and/or a building technology device, is provided. The process may be performed by the electronic component. The method may include sending a instruction query. Sending a instruction query may be performed according to the pull principle. The method may include sending a container availability query. Sending a container availability query may be performed according to the pull principle. The method may comprise receiving a software container and/or an instruction, wherein, based on the instruction, the software container may be retrieved and/or executed on the electronic component. Before executing the software container on the electronic component, a method according to the first aspect of the present invention may be carried out.

According to a third aspect of the present invention, a mobile device is provided. The mobile device may, in particular, be a smartphone. The mobile device may comprise a mobile application installed thereon and thereby be configured to perform a method according to the first aspect of the present invention.

According to a fourth aspect of the present invention, a server is provided which is configured to communicate with a mobile device. The server may be configured to perform a method according to the first aspect of the present invention.

According to a fourth aspect of the present invention, an electronic component is provided which may, in particular, comprise a field device and/or an automation device and/or a building technology device. The electronic component may, in particular, be configured to carry out a method according to the second aspect of the present invention.

According to a fifth aspect of the present invention, there is provided a system comprising a mobile device and a server, and preferably an electronic component, configured to perform a method according to the first and/or second aspect of the present invention.

According to a sixth aspect of the present invention, a computer program or a computer-readable medium is provided, comprising instructions which cause a computer, in particular a device according to the third and/or fourth and/or fifth aspect of the present invention, to carry out a method according to the first and/or second aspect of the present invention.

All features, technical details and advantages described with respect to one of the aspects of the present invention also apply mutatis mutandis to each of the other aspects of the present invention and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1: Shows a first schematic depiction of an example of the present invention.

FIG. 2: Shows a second schematic depiction of an example of the present invention.

FIG. 3: Shows a third schematic depiction of an example of the present invention.

FIG. 4: Shows a fourth schematic depiction of an example of the present invention.

FIG. 5: Shows an exemplary flowchart of an example of the present invention.

### DETAILED DESCRIPTION

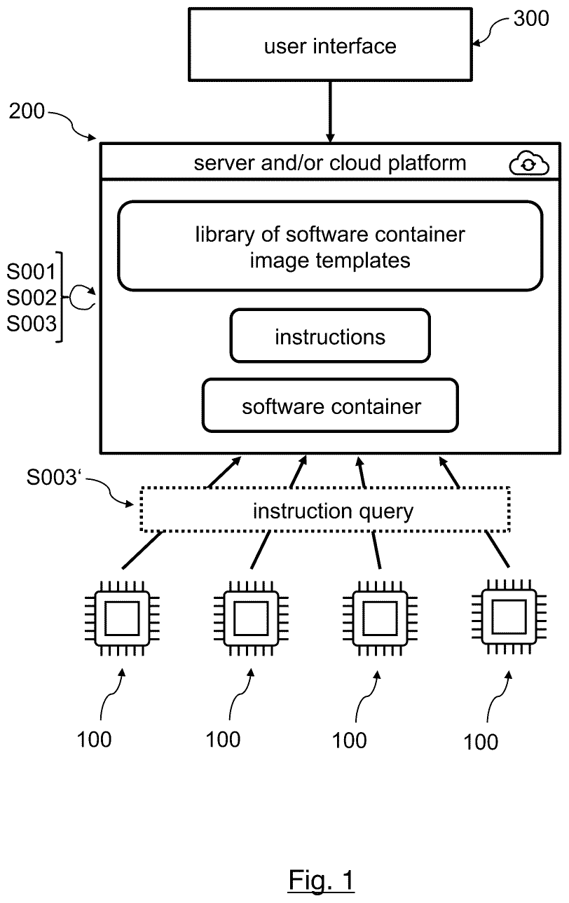

FIG. 1 is a first schematic depiction of an example of the present invention. Shown are technical components 100, a user interface 300, and a server 200. The user interface 300 may be a mobile device, a computer, and/or the like. The user interface 300 may further comprise a web-based application that may be executed, for example, by an Internet browser. Via the user interface 300, a user may make user inputs and thereby provide configuration information (step S001). Based on the received configuration information (step S001), the server 200 may create a software container (S002) which is executable on an electronic component 100 to configure the electronic component 100 according to the configuration information. Furthermore, the server 200 may generate an instruction that, when executed on the electronic component 100, causes the electronic component 100 to retrieve and/or execute, preferably retrieve and then execute, the software container. To provide the described functionalities, the server has a library of software container image templates that can serve as a template for creating software container images which may ultimately be used to create a software container (step S002). In this regard, the term “software container” may, in particular, can be understood as referring to an executable and/or executed instance of the software container image. FIG. 1 shows a stage in which the electronic components 100 perform an instruction query (step S003′).

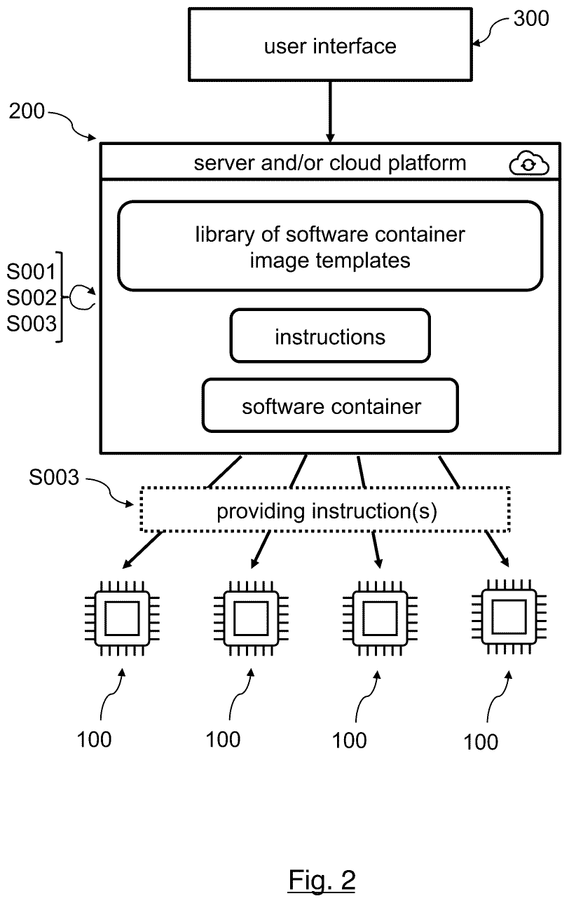

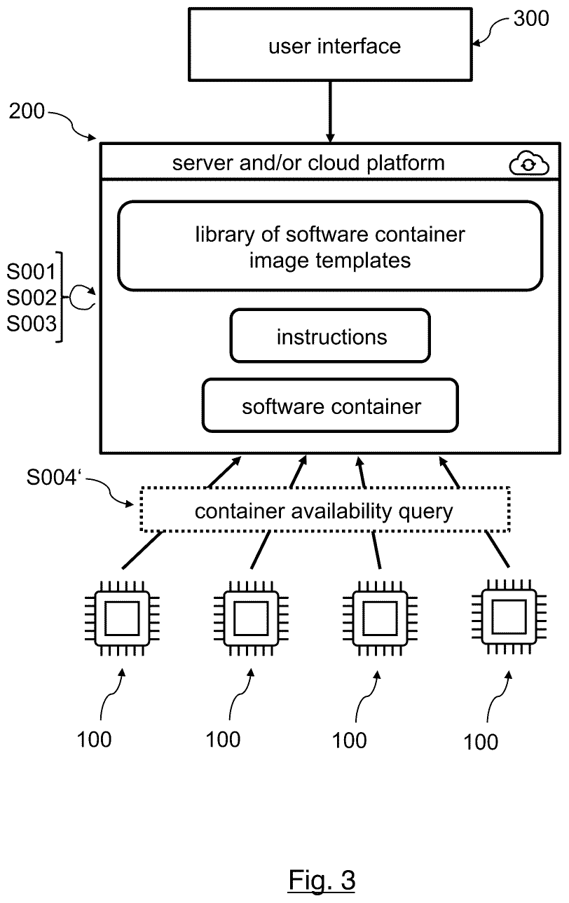

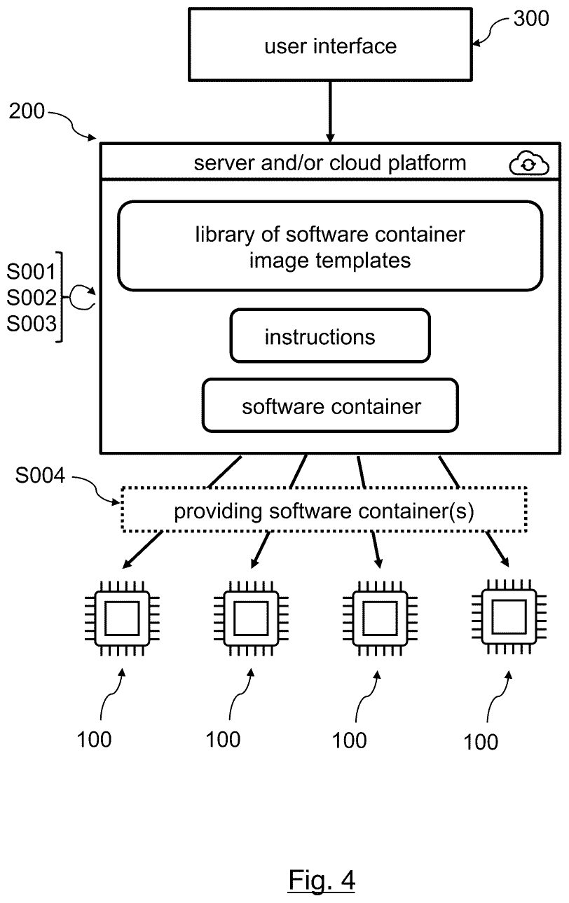

FIG. 2 differs from FIG. 1 in that it shows a stage in which the server 200 performs a provision of instruction(s) (step S003). In FIG. 3, the electronic components 100 perform a container availability query (step S004′). In FIG. 4, the server 200 provides software container(s) (step S004). In an example, FIGS. 1-4 may be understood as four successive stages of the method.

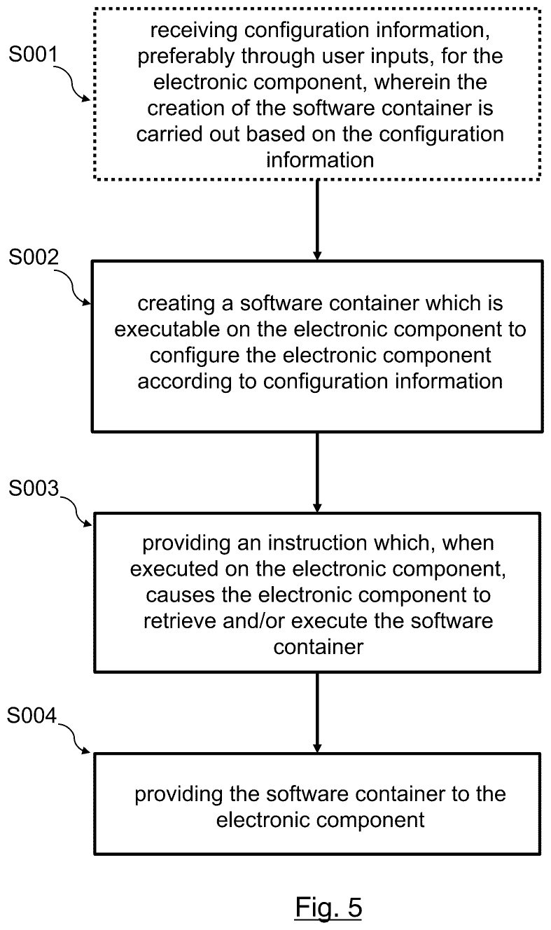

FIG. 5 shows a flowchart with steps according to an example of the present invention. Step S001 comprises obtaining configuration information, preferably through user input, for the electronic component 100, wherein the subsequent creation of the software container (S002) is performed based on the configuration information. This step is shown in dashed lines because it is optional. Step S002 comprises creating a software container which is executable on the electronic component 100 to configure the electronic component 100 according to configuration information. Step S003 comprises providing an instruction which, when executed on the electronic component 100, causes the electronic component 100 to retrieve and/or execute the software container. Step S004 comprises providing the software container to the electronic component.

In the following, steps of an example of the present invention are reproduced using a different wording to aid better understanding.

Software containers which may perform the necessary configurations and updates when executed on the industrial product are created and provided in a registry. In addition, a user interface is created that allows selecting configurations and updates for multiple devices. In a back-end system, the choice of configurations and updates is used to generate instructions that define which software containers must be executed in which order on the industrial products in order to perform the configurations and updates. These instructions are transmitted to the industrial products via an IoT platform.

Through an authentication process or in an authentication process that authenticates the industrial product to a customer-based platform during the manufacturing of the industrial product or during the installation of the industrial product.

The user may plan configurations and updates for his industrial products via a user interface.

The back-end system generates an instruction regarding the selection and sequence of software containers to be executed, which may provide for the configurations and updates of the industrial product.

The user interface provides this instruction to an IoT platform.

The term “industrial product” may be understood as referring to an electronic component as described above. The term “back-end system” may be understood as a server as described above.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for configuring an electronic component, in particular a field device and/or an automation device and/or a building technology device, the method comprising:
creating a software container that is executable on the electronic component to configure the electronic component according to configuration information;
providing an instruction which, when executed on the electronic component, causes the electronic component to retrieve and/or execute the software container; and
providing the software container to the electronic component.

2. The method according to claim 1, wherein the method is at least partially performed by a server, a cloud platform, a mobile device, and/or a smartphone.

3. The method according to claim 1, further comprising:
receiving the configuration information through user inputs via a user interface for the electronic component, wherein the creating of the software container is carried out based on the configuration information.

4. The method according to claim 1, further comprising:
creating a software container image based on configuration information, wherein the software container image comprises computer-readable instructions and information about the runtime environment and/or libraries and/or environment variables, wherein the creating of the software container is carried out based on the software container image, and wherein the created software container image is unchangeable.

5. The method according to claim 4, wherein the creating of the software container image is based on a library of software container image templates.

6. The method according to claim 1, wherein the provision of the instruction takes place in response to an instruction query of the electronic component according to the pull principle.

7. The method according to claim 1, wherein the provision of the software container takes place in response to a container availability query of the electronic component according to the pull principle.

8. The method according to claim 6, wherein the instruction query and/or the container availability query is repeated in a time-controlled manner or periodically; and/or
wherein the instruction query and/or the container availability query is performed based on a query command.

9. The method according to claim 1, wherein, based on the configuration information, multiple software containers are created, the method further comprising:
specifying an order for the execution of the multiple software containers based on a set of rules and optionally based on a collision check.

10. A method for configuring an electronic component, in particular a field device and/or an automation device and/or a building technology device, wherein the method is carried out by the electronic component, the method comprising:
optionally, sending an instruction request according to the pull principle;
optionally, sending a container availability request according to the pull principle; and
receiving a software container and/or an instruction, wherein, based on the instruction, the software container is retrieved and/or executed on the electronic component,
wherein the method according to claim 1 is carried out before the execution of the software container on the electronic component.

11. A mobile device with a mobile application installed thereon, configured to carry out the method according to claim 1.

12. A server configured to communicate with a mobile device, the server being configured to perform the method according to claim 1.

13. An electronic component, in particular a field device and/or an automation device and/or a building technology device, which is configured to carry out the method according to claim 10.

14. A system comprising a mobile device and a server and an electronic component configured to perform the method according to claim 1.

15. A computer program or a computer-readable medium comprising instructions which cause a computer to carry out the method according to claim 1.
